(19) United States
(12) Patent Application Publication
(10) Pub. No.: US 2016/0381094 A1
(43) Pub. Date: Dec. 29, 2016

(54) COMMUNICATION TERMINAL, COMMUNICATION SYSTEM, COMMUNICATION CONTROL METHOD, AND RECORDING MEDIUM

(71) Applicant: Takeru INOUE, Kanagawa (JP)

(72) Inventor: Takeru INOUE, Kanagawa (JP)

(21) Appl. No.: 15/194,837

(22) Filed: Jun. 28, 2016

(30) Foreign Application Priority Data
Jun. 29, 2015 (JP) 2015-130017
Nov. 2, 2015 (JP) 2015-215614

(51) Int. Cl. H04L 29/06; H04L 12/46; H04L 12/66

(52) U.S. Cl. CPC H04L 65/403; H04L 12/66; H04L 12/46; H04L 65/1063

(57) ABSTRACT

A communication terminal determines whether counterpart information of a candidate counterpart communication terminal obtained from a memory is described in a first format or a second format, and transmits a communication start request to one of a first server and a second server based on a determination. When the determination indicates that the obtained counterpart information is described in the first format, the communication start request is transmitted to the first server on the first network. When the determination indicates that the obtained counterpart information is described in the second format, the communication start request is transmitted to the second server on the second network.

### CROSS-REFERENCE TO RELATED APPLICATIONS

This patent application is based on and claims priority pursuant to 35 U.S.C. §119(a) to Japanese Patent Application No. 2015-130017, filed on Jun. 29, 2015, and 2015-215614, filed on Nov. 2, 2015, in the Japan Patent Office, the entire disclosure of which is hereby incorporated by reference herein.

### BACKGROUND

Technical Field

The present invention relates to a communication terminal, a communication system, a communication control method, and a recording medium.

Description of the Related Art

With the increased needs for reducing costs and times for business trips, communication systems that allow communication among communication terminals via a communication network are widely used.

In such communication systems, the communication terminal may communicate with the counterpart communication terminal via the Internet using the Internet communication service, or via the Intranet using the Intranet communication service.

### SUMMARY

Example embodiments of the present invention include a communication terminal connected to at least a first server through a first network and a second server through a second network. The communication terminal includes: a memory to store, for each one of one or more candidate counterpart communication terminals that the communication terminal is capable of communicating with, counterpart information to be used for connecting with the candidate counterpart communication terminal; circuitry to receive selection of at least one candidate counterpart communication terminal from among the one or more candidate counterpart communication terminals being displayed on a display, and determine whether counterpart information of the selected candidate counterpart communication terminal that is obtained from the memory is described in a first format or a second format; and a transmitter to transmit a communication start request for starting communication with the selected counterpart communication terminal to one of the first server and the second server based on a determination. When the determination indicates that the obtained counterpart information is described in the first format, the communication start request is transmitted to the first server controlling communication on the first network, the first network being the Intranet. When the determination indicates that the obtained counterpart information is described in the second format, the communication start request is transmitted to the second server controlling communication on the second network, the second network being the Internet.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating a communication system according to an example embodiment of the present invention;

FIG. 2 is an external view illustrating a communication terminal of the communication system of FIG. 1;

FIG. 3 is a schematic block diagram illustrating a hardware configuration of the communication terminal of FIG. 2;

FIG. 4 is a schematic block diagram illustrating a hardware configuration of a communication management system of the communication system of FIG. 1;

FIG. 5 is a schematic block diagram illustrating a functional configuration of the communication terminal and the communication management system of the communication system of FIG. 1;

FIG. 6 is a data sequence diagram illustrating operation of preparing for starting communication, performed by the communication terminal, according to an embodiment of the present invention;

FIG. 7 is a flowchart illustrating operation of organizing counterpart information, performed by the communication terminal, according to an embodiment of the present invention;

FIG. 8 is an example screen of a contact list for display at the communication terminal;

FIG. 9 is a flowchart illustrating operation of determining a connection destination for the communication terminal, according to an embodiment of the present invention;

FIG. 10A is a data sequence diagram illustrating operation of processing a request for connecting with a counterpart communication terminal, which is transmitted from the communication terminal to the management system for controlling communication on the Intranet, according to an embodiment of the present invention;

FIG. 10B is a data sequence diagram illustrating operation of processing a request for connecting with a counterpart communication terminal, which is transmitted from the communication terminal to the management system for controlling communication on the Internet, according to an embodiment of the present invention;

FIG. 11 is a flowchart illustrating operation of organizing counterpart information, performed by the communication terminal, according to an embodiment of the present invention; and

FIG. 12 is a schematic diagram illustrating a communication system according to an example embodiment of the present invention.

The accompanying drawings are intended to depict example embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

Referring to the drawings, some embodiments of the present invention are described. In the following, a “communication terminal” may simply be referred to as a “terminal”, and a “communication management system” may simply be referred to as a “management system”.

<Configuration of Communication System>

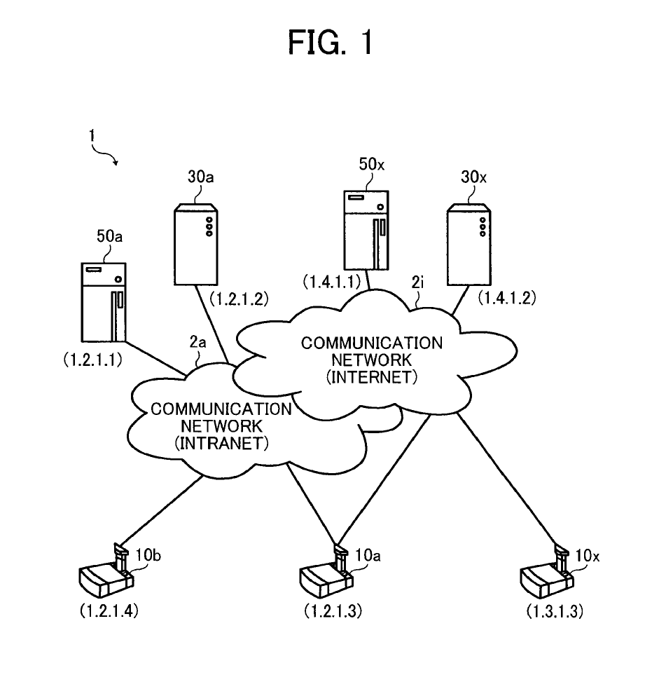

FIG. 1 is a schematic diagram illustrating a configuration of a communication system 1 according to an example embodiment of the present invention. The communication system 1 includes a plurality of terminals (10a, 10b, 10x), a plurality of relay devices (30a, 30x), and a plurality of management systems (50a, 50x). The communication system 1 controls communication of content data, such as image data and sound data, to carry out videoconference among a plurality of remotely located sites.

The terminals (10a, 10b), the relay device 30a, and the management system 50a are connected to one another through a communication network 2a, which may be implemented by the Intranet such as a local area network (LAN), a wide area network (WAN), and a virtual private network (VPN). The Intranet in this embodiment may be a dedicated network owned by an organization such as a company. The terminals (10a, 10x), the relay deice 30a, and the management system 50x are connected to one another through a communication network 2i, which may be implemented by the Internet. The communication network (2a, 2i) may not only include a wired network, but also a wireless network such as a network in compliance with WiFi (Wireless Fidelity) or Bluetooth, or a mobile phone network. Any one of the terminals (10a, 10b, 10x), the relay devices (30a, 30x), and the management systems (50a, 50x) may be located at any area, which may be the same to or different from that of the other terminal is located. As an example, FIG. 1 illustrates the case where the communication system 1 includes two management systems (50a, 50x). Alternatively, the communication system 1 may further include one or more management systems 50 to be communicable with the terminal 10.

In the following, any arbitrary terminal of the plurality of terminals (10a, 10b, 10x) is referred to as the terminal 10. Any arbitrary relay device of the relay devices (30a, 30x) is referred to as the relay device 30. In addition, any arbitrary of the plurality of management systems (50a, 50x) is referred to as the management system 50. Any arbitrary of the communication networks (2a, 2i) is referred to as the communication network 2.

In FIG. 1, four digits shown below each one of the terminals 10, the relay devices 30, and the management system 50 indicate a simplified expression of IP address that is assigned to each device capable of functioning as a communication device. For simplicity, the IP address is expressed in Internet Protocol version 4 (IPv4), but the IP address may be expressed in IPv6 instead.

The terminals 10 transmit or receive content data such as image data and audio data, to carry out communication among the users at respective terminals. More specifically, the terminal 10 transmits or receives content data using a predetermined communications protocol. The communications protocol used by the terminal 10 is mainly defined by a call control protocol used for connecting or disconnecting connections with the counterpart terminal, and an encoding format used for encoding the contents data to an IP packet.

Examples of the call control protocol being used by the terminal 10 include, but not limited to, (1) session initial protocol (SIP), (2) H.323, (3) the extended SIP, (4) Instant Messenger (IM) Protocol such as extensible messaging and presence protocol (XMPP), ICQ (Registered Trademark), AIM (Registered Trademark), or Skype (Registered Trademark), (5) protocol using the SIP message method, (6) Internet relay chat (IRC) protocol, and (7) extended IM based protocol such as Jingle.

<Hardware Configuration of Communication System>

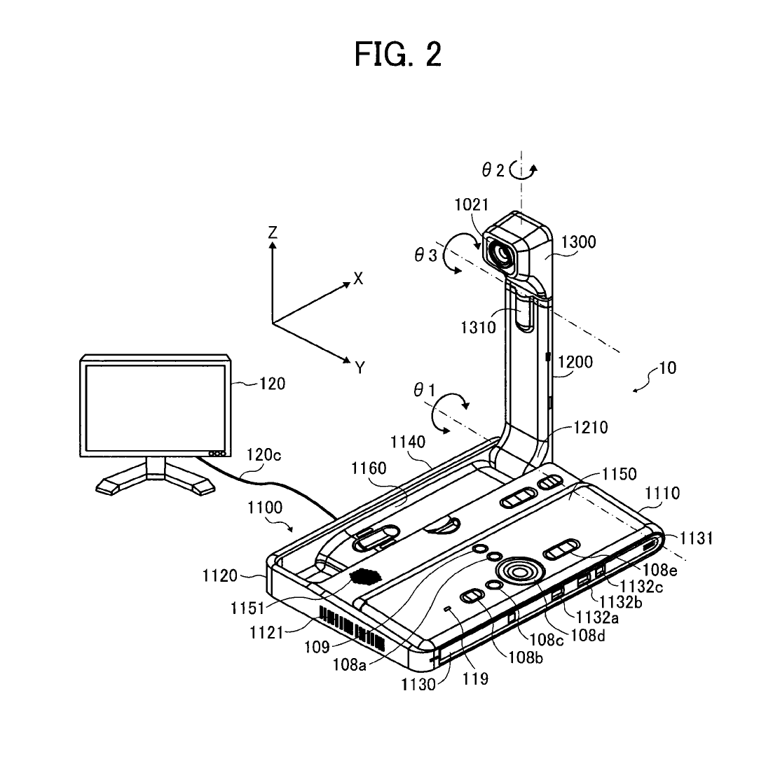

Now, a hardware configuration of the communication system 1 is described. FIG. 2 is an external view of the terminal 10 according to an example embodiment of the present invention.

As illustrated in FIG. 2, the terminal 10 includes a casing 1100, an arm 120, and a camera housing 1300. The casing 1100 includes a front side wall 1100 having a plurality of air intake holes formed over the nearly entire surface of the intake surface, and a back side wall 1120 having a plurality of exhaust holes over the nearly entire surface of the exhaust surface 1121. When a cooling fan in the casing 1100 is driven, air flows in through the intake holes of the intake surface and out through the exhaust holes of the exhaust surface 1121. The casing 1100 further includes a right side wall 1130 formed with a sound pickup hole 1131. Through the sound pickup hole 1131, a microphone 114 of the terminal 10 is able to catch sounds such as human voice or any sound including noise.

An operation panel 1150 is formed toward the right-side wall 1130 of the casing 1100. The operation panel 1150 includes a plurality of operation keys 108a to 108e, a power switch 109, and a plurality of sound output holes 1151. Through the sound output holes 1151, a speaker 115 of the terminal 10 is able to output sounds such as sounds generated based on human voice. The casing 1100 further includes a holder 1160, which is provided at the front surface toward the left side wall 1140. The holder 1160, which has a concave shape, accommodates therein the arm 1200 and the camera housing 1300. The right side wall 1130 is further provided with a plurality of connection ports 1132a to 1132c (“connection ports 1132”). The connection ports 1132 allow electrical connection to an external device through an external device connection I/F 118. The casing 1100 further includes a left side wall 1140, which is provided with a connection port to connect the external display 120 to the display I/F 117 through a cable 120c.

The following description uses the term “operation key(s) 108” for indicating an arbitrary one or ones of the operation keys (108a to 108e), and the term “connection port(s) 1132” for indicating an arbitrary one or ones of the connection ports (1132a to 1132c).

The arm 1200 is attached to the casing 1100 via a torque hinge 1210. With the torque hinge 1210, the arm 1200 can be rotated in directions of up and down with respect to the casing 1100, while making a tilt angle θ1 of up to 135 degrees. FIG. 2 illustrates a state in which the tilt angle θ1 is 90 degrees.

The camera housing 1300 incorporates therein the camera 112 that takes an image of an object. The object may be a part of a user, document, or a room where the terminal 10 is located. The camera housing 1300 is provided with a torque hinge 1310. The camera housing 1300 is attached to the arm 1200 through the torque hinge 1310. With the torque hinge 1310, the camera housing 1300 can be rotated with respect to the arm 1200, in the direction of up, down, right, and left, such that the camera housing 1300 is kept at a desired position. More specifically, the camera housing 1300 can be rotated, while making a pan angle θ2 from about −180 degrees to 180 degrees in the direction right and left, and a tilt angle θ3 that ranges from about −45 degrees to +45 degrees in the direction of up and down. In FIG. 2, the pan angle θ2 and the tilt angle θ3 are each 0 degree.

Note that the external view illustrated in FIG. 2 is only exemplary and the appearance is not restricted thereto. The communication terminal 10 may be, for example, a general-purpose computer (PC), a portable phone, a projector, an electronic whiteboard, or a digital signage. When the terminal 10, which may be implemented by a computer, is not provided with a microphone or a camera, any external microphone or external camera may be connected with the terminal 10. When the terminal 10 is implemented by the PC or the portable phone, the terminal 10 is connected to the communication network 2 through a wireless network such as a wireless LAN or mobile phone network. Further, when the terminal 10 is implemented by PC, such PC may be previously installed with application for enabling the PC to function as the videoconference terminal 10 of FIG. 2 as described below.

Since the relay device 30 and the management system 50 each have the same appearance as that of a general server computer, a description of the appearance thereof is omitted.

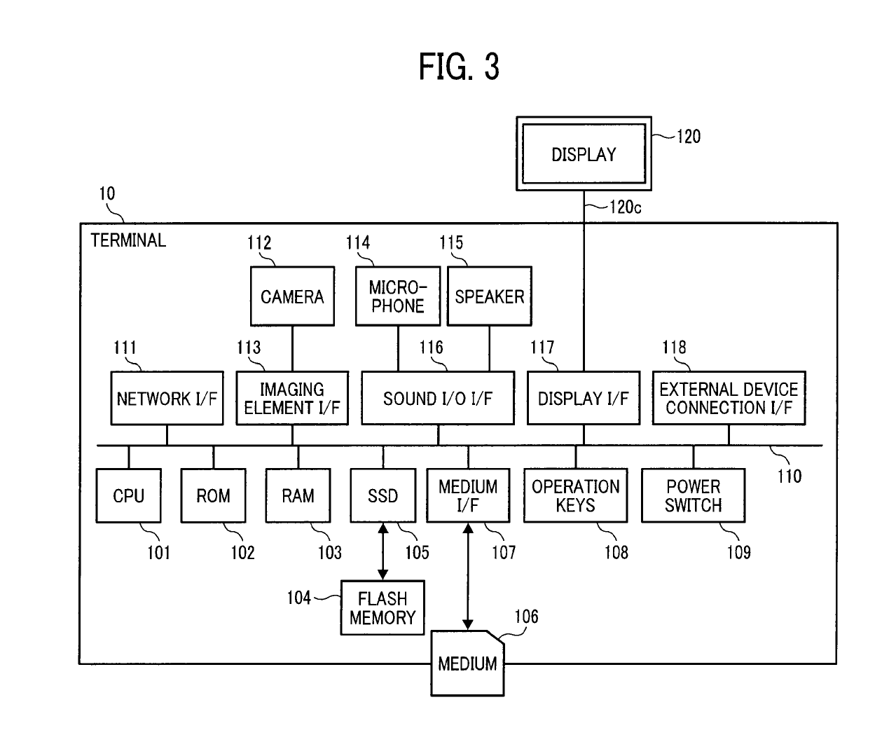

FIG. 3 illustrates a hardware configuration of the terminal 10 according to the embodiment of the present invention. The terminal 10 includes a central processing unit (CPU) 101 that controls entire operation of the terminal 10, a read-only memory (ROM) 102 that stores a program used for driving the CPU 101, such as an initial program loader (IPL), a random-access memory (RAM) 103 used as a work area for the CPU 101, a flash memory 104 that stores various types of data, such as the terminal control program, image data, and sound data, a solid state drive (SSD) 105 that controls reading/writing of various types of data from/to the flash memory 104 under control of the CPU 101, a medium I/F 107 (such as a medium drive) that controls reading/writing (storage) of data from/to a recording medium 106 such as a flash memory or an IC card, the operation keys 108 operated in the case of, for example, selecting a counterpart terminal of the terminal 10, the power switch 109 for turning on/off the power of the terminal 10, and a network interface (I/F) 111 for transmitting data using the communication network 2.

The terminal 10 further includes the built-in camera 112 that captures an image of a subject and obtains image data under control of the CPU 101, an imaging element I/F 113 that controls driving of the camera 112, the built-in microphone 114 that receives a sound input, the built-in speaker 115 that outputs sounds, a sound input/output I/F 116 that processes inputting/outputting of a sound signal between the microphone 114 and the speaker 115 under control of the CPU 101, a display I/F 117 that transmits image data to an external display 120 under control of the CPU 101, the external device connection I/F 118 for connecting various external devices, and a bus line 110 such as an address bus and a data bus for electrically connecting the above-described elements as illustrated in FIG. 3.

The display 120 is a display formed of liquid crystal or organic electroluminescence (EL) that displays an image of a subject, an operation icon, or the like. The display 120 is connected to the display I/F 117 by the cable 120c. The cable 120c may be an analog red green blue (RGB) (video graphic array (VGA)) signal cable, a component video cable, a high-definition multimedia interface (HDMI) signal cable, or a digital video interactive (DVI) signal cable.

The camera 112 includes a lens and a solid-state imaging element that converts an image (video) of a subject to electronic data by converting light to electric charge. As the solid-state imaging element, for example, a complementary metal-oxide-semiconductor (CMOS) or a charge-coupled device (CCD) is used.

The external device connection I/F 118 is capable of connecting an external device such as an external camera, an external microphone, or an external speaker by using a Universal Serial Bus (USB) cable that is inserted into the connection port 1132 or the like. In the case where an external camera is connected, the external camera is driven in preference to the built-in camera 112 under control of the CPU 101. Similarly, in the case where an external microphone is connected or an external speaker is connected, the external microphone or the external speaker is driven in preference to the built-in microphone 114 or the built-in speaker 115 under control of the CPU 101.

The recording medium 106 is removable from the terminal 10. In addition, a non-volatile memory that reads or writes data under control of the CPU 101 is not limited to the flash memory 104, and an electrically erasable and programmable read-only memory (EEPROM) may be used instead.

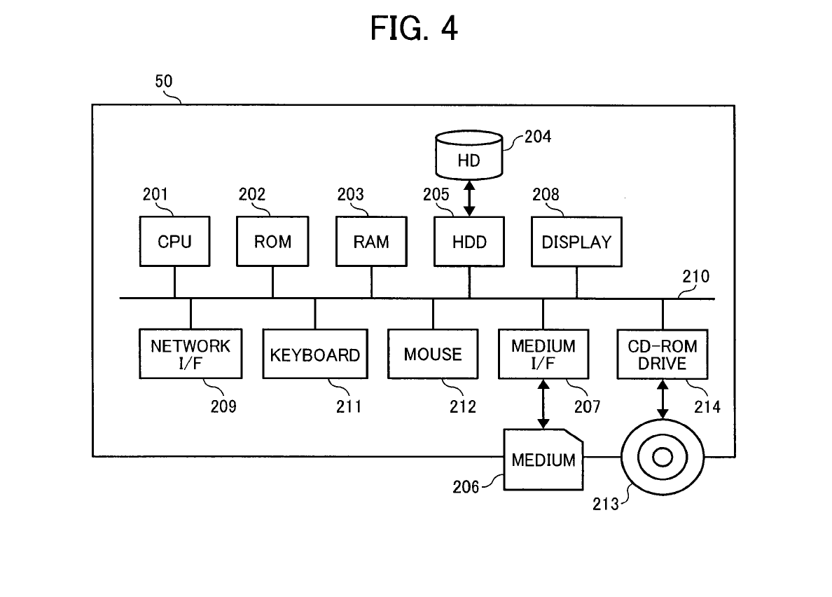

FIG. 4 illustrates a hardware configuration of the management system 50 according to the embodiment. The management system 50 includes a CPU 201 that controls entire operation of the management system 50, a ROM 202 that stores a program used for driving the CPU 201 such as an IPL, a RAM 203 used as a work area for the CPU 201, the HD 204 that stores various types of data such as the communication management program, a hard disk drive (HDD) 205 that controls reading/writing of various types of data from/to the HD 204 under control of the CPU 201, a medium I/F 207 (such as a medium drive) that controls reading/writing (storage) of data from/to a recording medium 206 such as a flash memory, a display 208 that displays various types of information such as a cursor, a menu, a window, characters, or an image, a network I/F 209 for transmitting data using the communication network 2, a keyboard 211 including a plurality of keys for entering characters, numerals, and various instructions, a mouse 212 that selects and executes various instructions such as selection of a processing target or movement of the cursor, a compact disc read-only memory (CD-ROM) drive 214 that controls reading/writing of various types of data from/to a CD-ROM 213 serving as an example of a removable recording medium, and a bus line 210 such as an address bus and a data bus for electrically connecting the above-described elements.

Since the relay device 30 has a hardware configuration that is the same as or similar to that of the above-described management apparatus 50, descriptions thereof are omitted.

<Functional Configuration of Communication System>

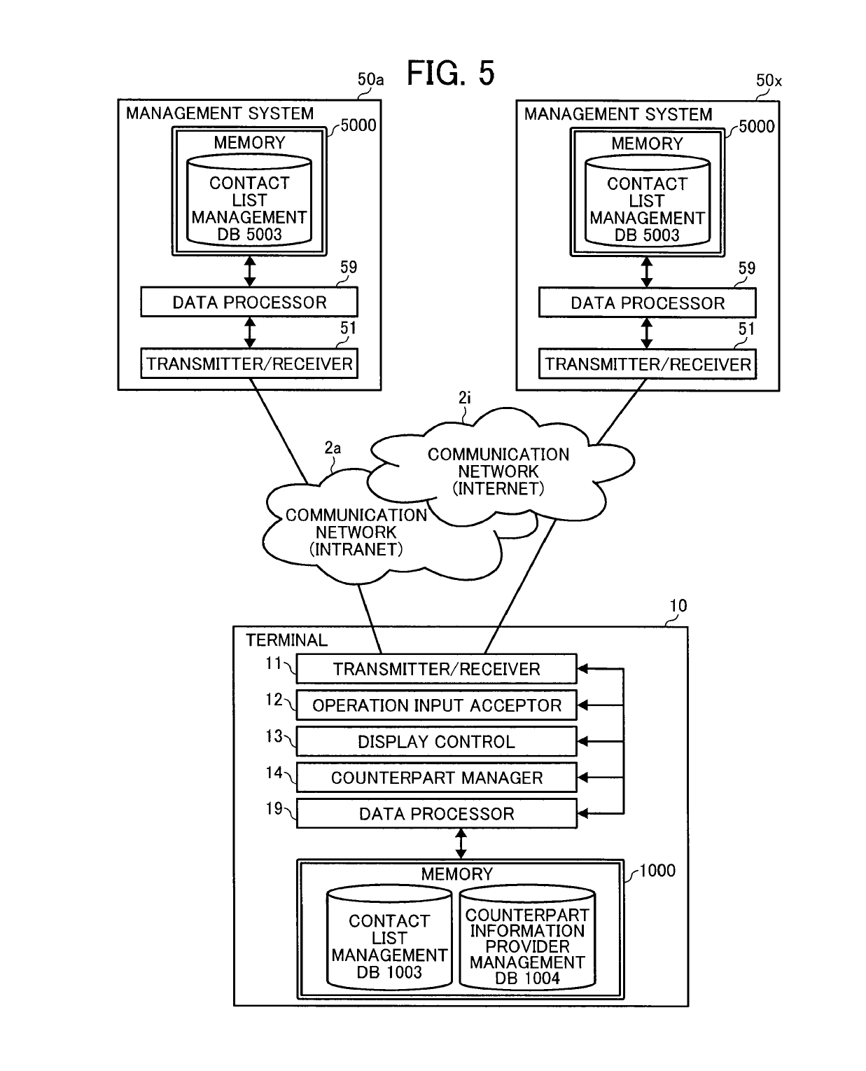

Now, functional configuration of the communication system 1 is explained. FIG. 5 is a schematic block diagram illustrating a functional configuration of the terminal 10 and the management system 50 in the communication system 1. In FIG. 5, the terminal 10 and the management system 50 are connected through the communication network 2 to transmit or receive data.

<Functional Configuration of Management System>

The management system 50 (50a, 50x) includes a transmitter/receiver 51 and a data processor 59. These elements correspond to a plurality of functions of hardware elements in FIG. 4, which operate according to the instructions of the CPU 201 (FIG. 4) that are generated according to the communication management program read from the RAM 203 onto the HD 204. The management system 50 (50a, 50x) further includes a memory 5000, which may be implemented by the HD 204. The memory 5000 further stores a plurality of databases (DBs) as described below.

(Contact List Management Table)

Table 1 is a contact list management table, which is managed by the management system 50a. The memory 5000 of the management system 50a stores a contact list management DB 5003 implemented by the contact list management table described below as Table 1. The contact list management table stores, for each one of a plurality of terminals 10 as a starting terminal, a contact ID for identifying the starting terminal, counterpart information indicating a counterpart terminal that can be selected by the starting terminal, and a counterpart name (terminal name) of the counterpart terminal in association with one other. The contact ID is any information for identifying a communication destination in the communication system 1. Examples of contact ID include, but not limited to, terminal identification information for identifying the terminal 10 such as the terminal ID, and identification information for identifying a user of the terminal 10 such as a user account. In the following, it is assumed that the terminal identification information is used as the contact ID of the terminal 10. Further, in the following, it is assumed that the terminal 10a is assigned with the contact ID “01a”, the terminal 10b is assigned with the contact ID “01b”, and the terminal 10x is assigned with the contact ID “01x”.

The counterpart information is any information for identifying a connection destination to be used by the terminal 10 (starting terminal) to connect with the counterpart terminal. The management system 50a controls communication among the terminals 10 through the Intranet (communication network 2a). Since a connection destination of the counterpart terminal 10 to be connected can be identified with an IP address within the Intranet, the management system 50a stores an IP address as counterpart information in the contact list management table “Table 1”.

TABLE 1

| Starting Terminal | Counterpart | Counterpart |
|---|---|---|
| Contact ID | Information | Name |
| 01a | 1.2.1.4 | ABC Company, Terminal B |
| 01a | 1.2.1.5 | ABC Company, Terminal C |
| . . . | . . . | . . . |

Referring to Table 1, for the starting terminal 10a, the counterpart information and the counterpart name for the terminals 10b, 10c, etc., are stored.

Table 2 is a contact list management table managed by the management system 50x. The memory 5000 of the management system 50x stores a contact list management DB 5003 implemented by the contact list management table described below as Table 2. The contact list management table stores, for each one of a plurality of terminals 10 as a starting terminal, a contact ID for identifying the starting terminal, counterpart information indicating a counterpart terminal that can be selected by the starting terminal, and a counterpart name (terminal name) of the counterpart terminal in association with one other.

The management system 50x controls communication among the terminals 10 through the Internet (communication network 2i). As the terminal 10 logs in the management system 50, the management system 50x obtains an IP address for the Internet connection, of the terminal 10, and stores the obtained IP address in association with the contact ID of the login terminal 10. With this correspondence information, the management system 50x is able to obtain an IP address of the counterpart terminal 10 using the contact ID of the counterpart terminal 10. The management system 50x thus stores the contact ID (in this example, the terminal identification information) as the counterpart information in the contact list management table “Table 2”.

TABLE 2

| Starting Terminal | Counterpart | Counterpart |
|---|---|---|
| Contact ID | Information | Name |
| 01a | 01x | XYZ Company, Terminal X |
| 01a | 01y | XYZ Company, Terminal Y |
| . . . | . . . | . . . |

Referring to Table 2, for the starting terminal 10a, the counterpart information and the counterpart name for the terminals 10x, 10y, etc., are stored.

(Functional Configuration of Management System)

Next, referring back to FIG. 5, functional configuration of the management system 50 (50a, 50x) will be described in detail. In the following description of functional configuration of the management system 50 (50a, 50x), relationships of the hardware components in FIG. 4 with functional configuration of the management system 50 in FIG. 5 is also described.

The transmitter/receiver 51, which may be implemented by the instructions of the CPU 201 and the network I/F 209, transmits or receives various data (or information) to or from each terminal, device, or system through the communication network 2.

The data processor 59, which may be implemented by the instructions of the CPU 201 and the HDD 205, or the instructions of the CPU 201, stores various data in the memory 5000 or reads various data from the memory 5000.

<Functional Configuration of Terminal>

The terminal 10 includes a transmitter/receiver 11, an operation input acceptor 12, a display control 13, a counterpart manager 14, and a data processor 19. These units are functions that are implemented by or that are caused to function by operating any of the hardware components illustrated in FIG. 3 in cooperation with the instructions of the CPU 101 according to the terminal program expanded from the flash memory 104 to the RAM 103.

The terminal 10 further includes a memory 1000, which is implemented by the ROM 102, RAM 103, or flash memory 104 of FIG. 3. The memory 1000 further stores a plurality of databases (DBs) as described below.

(Contact List Management Table)

Table 3 is a contact list management table, which is managed by the terminal 10. The memory 1000 of the terminal 10 stores a contact list management DB 1003 implemented by the contact list management table described below as Table 3. The contact list management table stores, for the terminal 10 storing this contact list management table (local terminal), counterpart information indicating a counterpart terminal that can be selected by the local terminal, and a counterpart name (terminal name) of the counterpart terminal in association with one other.

The terminal 10 obtains the counterpart information and the counterpart name (terminal name) of each counterpart terminal, from the management system 50 (50a, 50x), and stores the obtained information in its contact list management table. For this reason, the counterpart information includes the IP address obtained from the management system 50a, and the contact ID obtained from the management system 50x. Table 3 stores the counterpart information and the counterpart name of the counterpart terminal for the starting terminal 10a.

TABLE 3

| Counterpart | Counterpart |
|---|---|
| Information | Name |
| 1.2.1.4 | ABC Company, Terminal B |
| 1.2.1.5 | ABC Company, Terminal C |
| 01x | XYZ Company, Terminal X |
| 01y | XYZ Company, Terminal Y |

(Counterpart Information Provider Management Table)

Table 4 is a counterpart information provider management table, which is managed by the terminal 10. The memory 1000 of the terminal 10 stores a counterpart information provider management DB 1004 implemented by the counterpart information provider management table described below as Table 4. The counterpart information provider management table stores, for each server providing the counterpart information in the contact list management table, a server name, a type of communication network that the server resides (“network type”), and an uniform resource locator (URL) of the server, in association with one another. Any one of the server name, network type, and URL may be added, deleted, or modified, according to input from the terminal 10. The terminal 10 is able to obtain counterpart information to be stored in the contact list management table, from a plurality of servers, based on information stored in the counterpart information provider management table.

TABLE 4

| Server Name | Network Type | URL |
|---|---|---|
| Management | Intranet | http://1.2.1.1/10aa/address |
| System 50a | | |
| Management | Intranet | http://1.2.2.1/10aa/address |
| System 50b | | |
| Management | Internet | http://example.abc.com/10aa/address |
| System 50x | | |
| . . . | . . . | . . . |

(Functional Configuration of Terminal)

Next, functional configuration of the terminal 10 is explained in detail. In the following description of functional configuration of the terminal 10, relationships of the elements in FIG. 3 with the functional configuration of the terminal 10 in FIG. 5 will also be described.

The transmitter/receiver 11, which is implemented by instructions of the CPU 101 and the network I/F 111, transmits or receives various data (or information) to or from the counterpart terminal, each device or system, through the communication network 2.

The operation input acceptor 12, which may be implemented by instructions of the CPU 101, the operation keys (108a, 108b, 108c, 108d, 108e), and the power switch 109, receives various inputs or selections from the user.

The display control 13, which may be implemented by the instructions of the CPU 101 and the display I/F 117, controls display of an image through the display 120.

The counterpart manager 14, which may be implemented by the instructions of the CPU 101, manages counterpart information of a counterpart terminal. For example, when preparing to start communication with a counterpart terminal, the counterpart manager 14 generates a contact list, or obtains counterpart information of a counterpart terminal that is selected from the contact list.

The data processor 19, which may be implemented by the instructions of the CPU 101 and the SSD 105, or the instructions of the CPU 101, stores various data in the memory 1000 or reads various data from the memory 1000.

<Operation of Communication System>

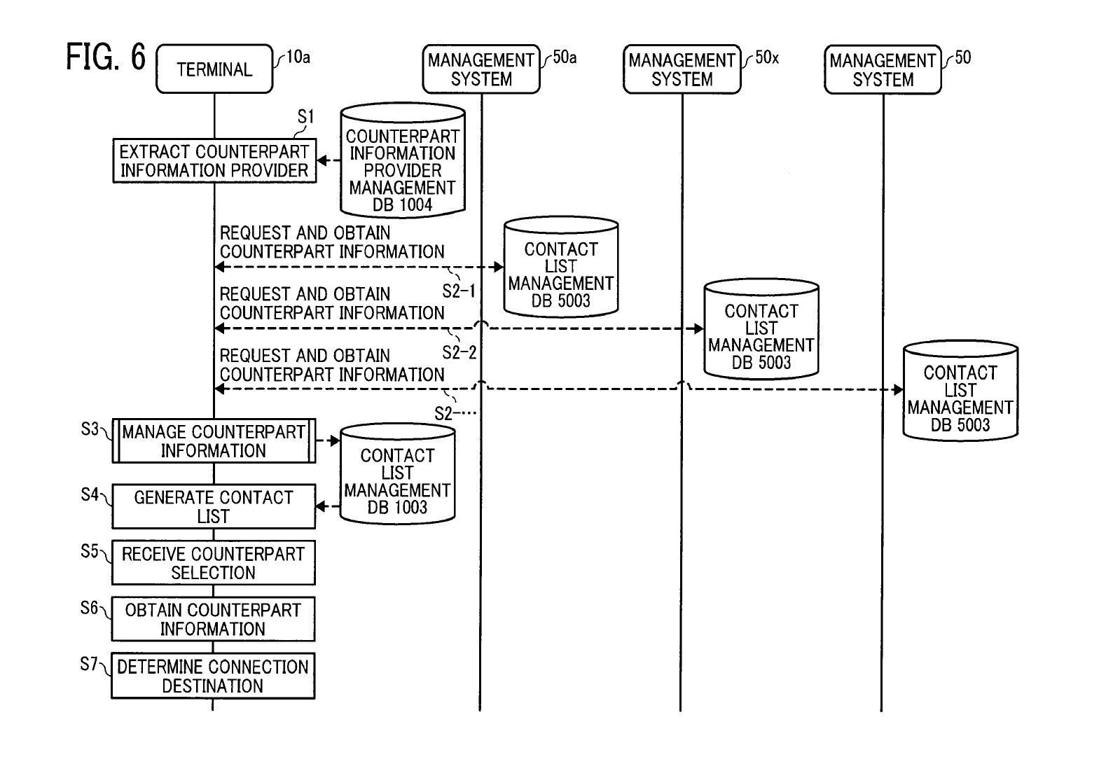

Now, operation performed by the communication system 1 is explained according to an example embodiment of the present invention. Referring to FIG. 6, operation of preparing for starting communication with a counterpart terminal, performed by the terminal 10a, is described according to an embodiment of the present invention. FIG. 6 is a data sequence diagram illustrating operation of preparing for communication by the communication terminal 10a. The operation of FIG. 6 includes selecting a counterpart terminal at the terminal 10a, and requesting the management system 50 to start communication with the selected counterpart terminal.

At any arbitrary time after the terminal 10a is turned on, at S1, the counterpart manager 14 of the terminal 10a extracts, from the counterpart information provider management table (Table 4), the name, the network type, and the URL of each server. The servers in this embodiment correspond to, for example, the management systems 50a, 50x, and 50.

The terminal 10a logs in each of the management systems (50a, 50x, . . . ) using the extracted information regarding each server. More specifically, the terminal 10a accesses each management system (50a, 50x, . . . ) with the URL obtained at S1 to request for counterpart information from each management system (50a, 50x, . . . ) (S2-1, S2-2, S2- . . . ). With the request, the terminal 10a sends the contact ID “01 a” of the terminal 10a. As the transmitter/receiver 51 of the management system (50a, 50x, . . . ) receives the request for counterpart information from the terminal 10a, the data processor 59 of the management system (50a, 50x, . . . ) searches the contact list management table (Table 1, Table 2, . . . ) using the contact ID “01a” of the terminal 10a as a search key to obtain the counterpart information and the counterpart name of one or more counterpart terminals that are stored in association with the contact ID “01a”. The transmitter/receiver 51 of the management system (50a, 50x, . . . ) transmits the obtained counterpart information and the counterpart name, to the terminal 10a. The transmitter/receiver 11 of the terminal 10a receives the counterpart information and the counterpart name of the counterpart terminal that can be selected by the terminal 10a, from each one of the management systems (50a, 50x, . . . ) (S2-1, S2-2, S2- . . . ). In case the terminal 10a fails to access the management system 50, or the contact list management table stored in the management system 50, the terminal 10a may retry to access at least a predetermined number of times. When retry fails, the counterpart manager 14 of the terminal 10a determines that obtaining the counterpart information has failed. In such case, the terminal 10a may display an error message.

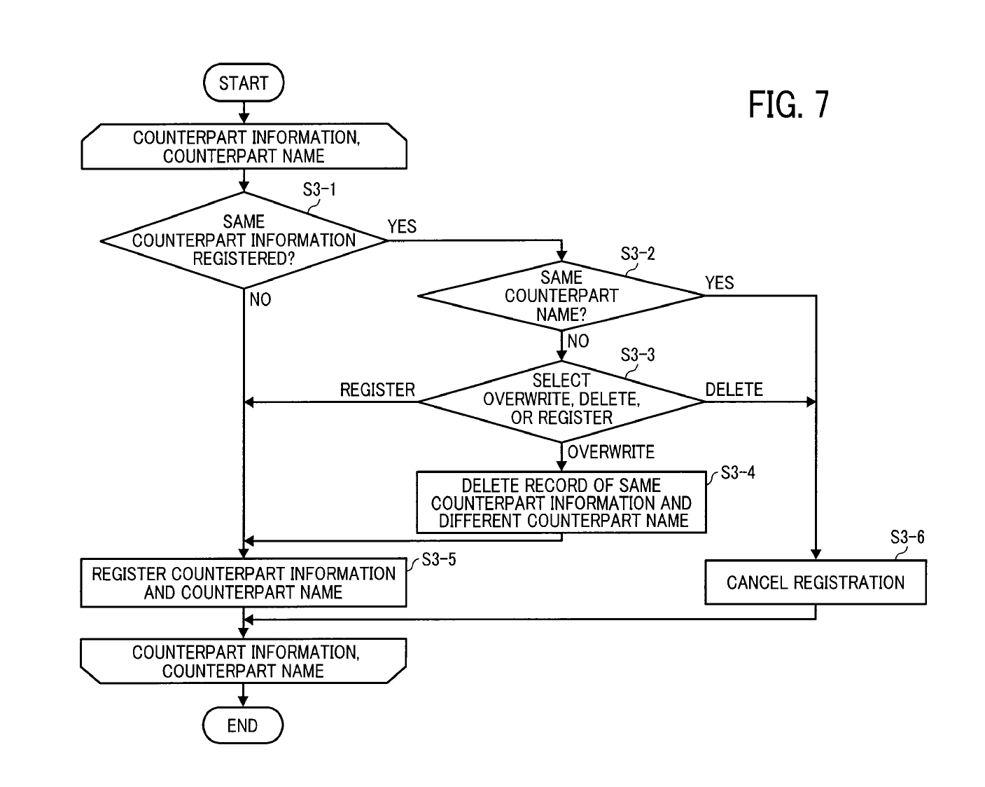

The data processor 19 of the terminal 10a stores, in its contact list management table (Table 3), the counterpart information and the counterpart name that are respectively obtained from the contact list management tables of different management systems (50a, 50x, . . . ). When storing, at S3, the terminal 10a organizes counterpart information as described below referring to FIG. 7. FIG. 7 is a flowchart illustrating operation of integrating information obtained from a plurality of contact list management tables, according to an embodiment of the present invention.

The operation of FIG. 7 is performed for each pair of counterpart information and counterpart name that is received at S2-1, S2-2, . . . . The pair of counterpart information and counterpart name, to be processed, may be selected in any order. At S3-1, the counterpart manager 14 determines whether the counterpart information of the target pair of counterpart information and counterpart name has been already registered in its contact list management table (Table 3).

When it is determined that the counterpart information of the target pair has been already registered (“YES” at S3-1), the operation proceeds to S3-2. At S3-2, the counterpart manager 14 refers to the contact list management table, and determines whether the counterpart information that is the same as the counterpart information of the target pair, is stored in association with a counterpart name that is the same as the counterpart name of the target pair.

When it is determined that the same counterpart information is registered but the same counterpart name is not registered (“NO” at S3-2), the display control 13 causes the display 120 to display a selection screen to request for further instructions. The selection screen allows the user at the terminal 10a to overwrite, delete, or additionally register the target pair of counterpart information and counterpart name. At S3-3, the operation input acceptor 12 of the terminal 10a receives a user instruction that selects overwrite, delete, or additionally register.

When “register” is selected at S3-3, at S3-5, the counterpart manager 14 registers the target (received) pair of counterpart information and counterpart name in the contact list management table, as a record separate from the registered pair of same counterpart information and different counterpart name.

When “overwrite” is selected at S3-3, at S3-4, the counterpart manager 14 deletes the registered pair of same counterpart information and different counterpart name, from the contact list management table. The counterpart manager 14 then registers the target (received) pair of counterpart information and counterpart name to the contact list management table at S3-5.

When “delete” is selected at S3-3, at S3-6, the counterpart manager 14 determines to delete the target (received) pair of counterpart information and counterpart name, such that the received pair of counterpart information and counterpart name is not registered in the contact list management table.

The counterpart manager 14 of the terminal 10a repeats S3-1 to one of S3-4, S3-5, and S3-6 for each pair of counterpart information and counterpart name that is received from the management systems (50a, 50x . . . ). Through the above-described operation, the counterpart information and counterpart name that are obtained from the plurality of contact list management tables are integrated into the contact list management table of the terminal 10a, according to the user preference, even when there are more than one record for the same counterpart terminal.

The operation of FIG. 7 is just one example of organizing information to be stored in the contact list management table, such that the contact list management table may be organized in various other ways. For example, the counterpart manager 14 may store a result of selection at S3-3 in the memory 1000, when S3-3 is performed. For a subsequent time that the counterpart manager 14 finds a pair of the same counterpart information and different counterpart name, the counterpart manager 14 may automatically select whether to overwrite, delete, or register, based on the stored result of selection.

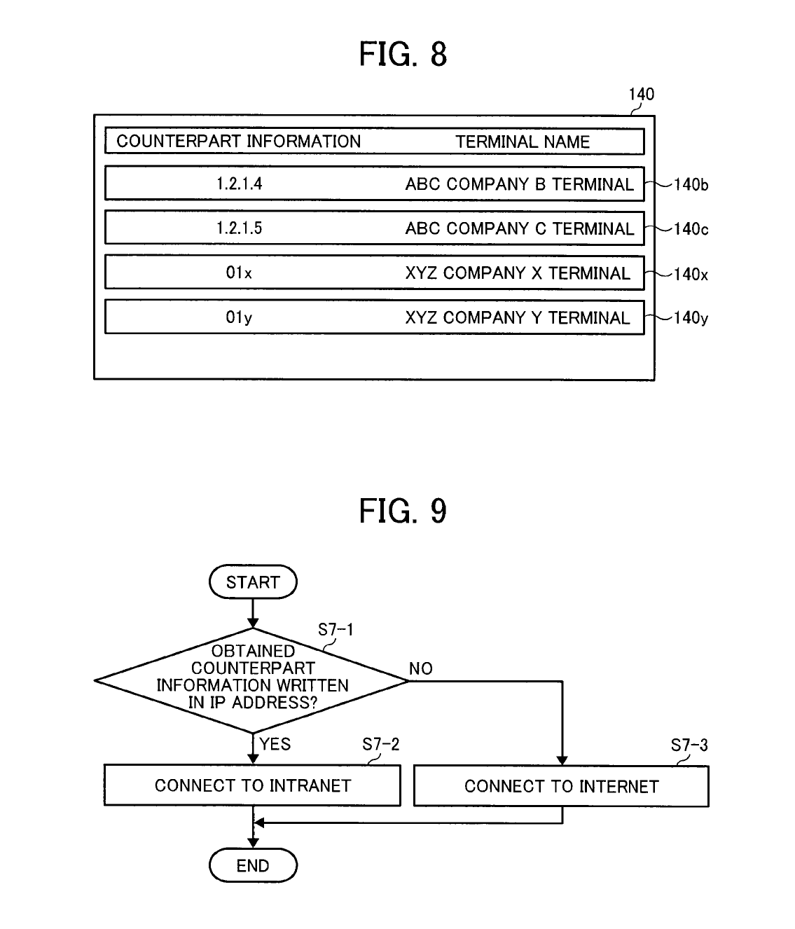

The operation after S3 is described below referring to FIG. 6. In response to a user instruction for contact list, which is received by the operation input acceptor 12, at S4, the counterpart manager 14 generates a contact list screen based on the contact list management table. The contact list now includes the counterpart information and the counterpart name, which are received from the management systems (50a, 50x, . . . ), as described above referring to S3. The display control 13 causes the display 120 to display the contact list screen that is generated. FIG. 8 is an illustration of an example contact list screen 140. As illustrated in FIG. 8, the contact list screen 140 includes a plurality of keys 140b, 140c, 140x, and 140y (collectively referred to as the key 140), each displaying the counterpart information and the counterpart name in association. The key 140 may not display thereon the counterpart information, as long as the counterpart name or any information that helps the user to recognize the counterpart is displayed. The counterpart manager 14 generates the key 140, such that it has a link to the counterpart information of the displayed counterpart name.

Referring back to FIG. 6, at S5, the operation input acceptor 12 receives a user instruction that selects at least one key 140 displaying at least information for identifying the counterpart such as the counterpart name. At S6, the counterpart manager 14 obtains the counterpart information, using the link of the selected key 140.

At S7, the counterpart manager 14 determines a connection destination of the terminal 10a, based on the obtained counterpart information. Referring to FIG. 9, S7 of determining the connection destination is described. FIG. 9 is a flowchart illustrating operation of determining the connection destination.

At S7-1, the counterpart manager 14 determines whether the counterpart information that is obtained at S6 is an IP address. When it is determined that the obtained counterpart information is the IP address (“YES” at S7-1), the operation proceeds to S7-2. At S7-2, the counterpart manager 14 connects to the Intranet (communication network 2a), to request the management system 50a on the Intranet to connect to the selected counterpart terminal. When it is determined that the obtained counterpart information is not the IP address (“NO” at S7-1), the operation proceeds to S7-3. At S7-3, the counterpart manager 14 connects to the Internet (communication network 2i), to request the management system 50x on the Internet to connect to the selected counterpart terminal.

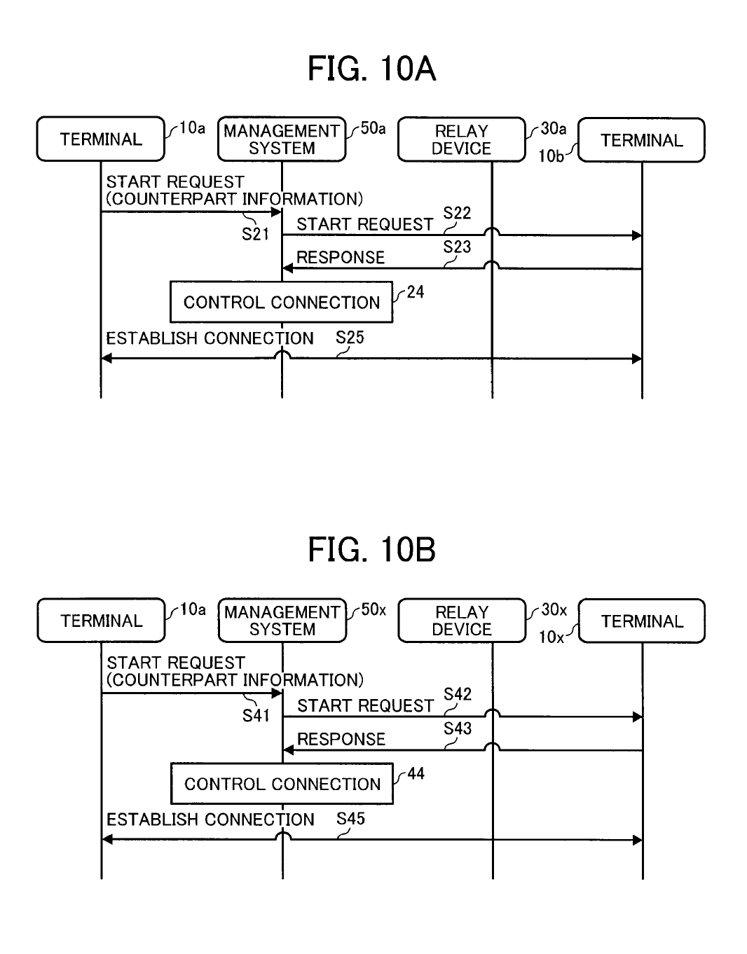

Referring to FIG. 10A, operation of requesting the management system 50a to connect to the counterpart terminal is described according to an embodiment of the present invention. FIG. 10A is a data sequence diagram illustrating operation of connecting to the counterpart terminal through the Intranet. In this example, the counterpart manager 14 obtains the counterpart information “1.2.1.4” in IP address format (See FIG. 8), and determines to request the management system 50a to connect with the counterpart terminal (S7-2).

At S21, the transmitter/receiver 11 of the terminal 10a transmits a communication start request to the management system 50a through the Intranet, which requests to start communication with the counterpart terminal 10b identified with the counterpart information “1.2.1.4”. The communication start request includes the counterpart information “1.2.1.4” obtained at S6. At S22, the transmitter/receiver 51 of the management system 50a transmits the communication start request, to the terminal 10b that is the counterpart terminal for the terminal 10a.

At S23, the transmitter/receiver 11 of the terminal 10b, which receives the communication start request, sends a response to the communication start request according to a user instruction, to the management system 50a. The following describes the case where the terminal 10b sends a response indicating to accept the communication start request.

In response to receiving the response accepting the communication start request, at S24, the transmitter/receiver 51 of the management system 50a controls to establish a communication session based on the Intranet via the relay device 30a between the terminals 10a and 10b, using any desired method. As the communication session is established between the terminals 10a and 10b, at S25, the terminals 10a and 10b exchange image data and audio data via the relay device 30a. The image data may be image data of a user at each terminal 10, or image data of a presentation material. The relay device 30a relays image data and audio data between the terminal 10a and the terminal 10b. Thus, the terminals 10a and 10b can start a videoconference between two sites.

Referring to FIG. 10B, operation of requesting the management system 50x to connect to the counterpart terminal is described according to an embodiment of the present invention. FIG. 10B is a data sequence diagram illustrating operation of connecting to the counterpart terminal through the Internet. In this example, the counterpart manager 14 obtains the counterpart information “01x” in contact ID format (See FIG. 8), and determines to request the management system 50x to connect with the counterpart terminal (S7-3).

At S41, the transmitter/receiver 11 of the terminal 10a transmits a communication start request to the management system 50x through the Internet, which requests to start communication with the counterpart terminal 10x identified with the counterpart information “01x”. The communication start request includes the counterpart information “01x” obtained at S6. At S42, the transmitter/receiver 51 of the management system 50x transmits the communication start request, to the terminal 10x that is the counterpart terminal for the terminal 10a.

At S43, the transmitter/receiver 11 of the terminal 10x, which receives the communication start request, sends a response to the communication start request according to a user instruction, to the management system 50x. The following describes the case where the terminal 10x sends a response indicating to accept the communication start request.

In response to receiving the response accepting the communication start request, at S44, the transmitter/receiver 51 of the management system 50x controls to establish a communication session based on the Internet via the relay device 30x between the terminals 10a and 10x, using any desired method. As the communication session is established between the terminals 10a and 10x, at S45, the terminals 10a and 10x exchange image data and audio data via the relay device 30x. The image data may be image data of a user at each terminal 10, or image data of a presentation material. The relay device 30x relays image data and audio data between the terminal 10a and the terminal 10x. Thus, the terminals 10a and 10x can start a videoconference between two sites.

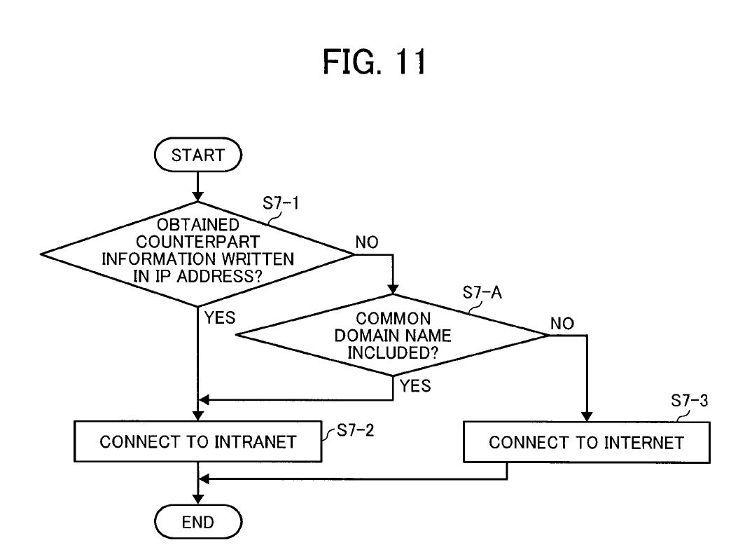

Referring to FIG. 11, operation of determining a connection destination based on counterpart information is described according to a modified example. In this example, the contact list management tables stored in the management systems 50a and 50x store counterpart information in a domain format.

Table 5 is a contact list management table managed by the management system 50a in this embodiment. The contact list management table, specifically, Table 5 stores the counterpart information in an IP address format and a domain format. The counterpart information in domain includes, for example, a domain name “example.abc.com” of a host server of the ABC Company.

TABLE 5

| Starting Terminal | Counterpart | Counterpart |
|---|---|---|
| Contact ID | Information | Name |
| 01a | b@example.abc.com | ABC Company, Terminal B |
| 01a | 1.2.1.5 | ABC Company, Terminal C |
| . . . | . . . | . . . |

Table 6 is a contact list management table managed by the management system 50x in this embodiment. The contact list management table, specifically, Table 6 stores the counterpart information in a contact ID format and a domain format. The counterpart information in domain includes, for example, a domain name “example.xyz.com” of a host server of the XYZ Company.

TABLE 6

| Starting Terminal | Counterpart | Counterpart |
|---|---|---|
| Contact ID | Information | Name |
| 01a | x@example.xyz.com | XYZ Company, Terminal X |
| 01a | 01y | XYZ Company, Terminal Y |
| . . . | . . . | . . . |

As described above referring to S3 of FIG. 6, as the terminal 10a receives the counterpart information and the counterpart name, respectively, from the management systems 50a and 50x, the data processor 19 of the terminal 10a stores the obtained counterpart information and counterpart name in its contact list management table. Accordingly, the contact list management table of the terminal 10a stores therein the counterpart information and the counterpart name of each counterpart terminal, as illustrated in Table 7. Table 7 is a contact list management table managed by the terminal 10a.

TABLE 7

| Counterpart | Counterpart |
|---|---|
| Information | Name |
| b@example.abc.com | ABC Company, Terminal B |
| 1.2.1.5 | ABC Company, Terminal C |
| x@example.xyz.com | XYZ Company, Terminal X |
| 01y | XYZ Company, Terminal Y |

FIG. 11 is a flowchart illustrating operation of determining the connection destination according to this example. The operation of FIG. 11 is substantially similar to the operation of FIG. 9, except for addition of S7-A. When it is determined that the obtained counterpart information is not the IP address (“NO” at S7-1), the operation proceeds to S7-A. At S7-A, the counterpart manager 14 determines whether the counterpart information shares a domain name that is the same as that of the local terminal 10a. More specifically, the counterpart manager 14 compares between the counterpart information obtained at S6 and the counterpart information of the local terminal 10a in a domain format. For example, assuming that the terminal 10a has the counterpart information in a domain format “a@example.abc.com”, and the counterpart information obtained at S6 is expressed as “b@example.abc.com”, at S7-A, the counterpart manager 14 determines that the common domain name is included. On the other hand, assuming that the terminal 10a has the counterpart information in a domain format “a@example.abc.com”, and the counterpart information obtained at S6 is expressed as “x@example.xyz.com”, at S7-A, the counterpart manager 14 determines that the common domain name is not included.

When it is determined that the obtained counterpart information has the common domain name (“YES” at S7-A), the operation proceeds to S7-2. At S7-2, the counterpart manager 14 connects to the Intranet (communication network 2a), to request the management system 50a on the Intranet to connect to the selected counterpart terminal. When it is determined that the obtained counterpart information does not have the common domain name (“NO” at S7-A), the operation proceeds to S7-3. At S7-3, the counterpart manager 14 connects to the Internet (communication network 2i), to request the management system 50x on the Internet to connect to the selected counterpart terminal. The management system 50x may request a domain name server for an IP address associated with the domain name of the obtained counterpart information, to identify the counterpart terminal. The management system 50x then establishes a communication session between the terminal 10a and the counterpart terminal 10. As described above referring to FIG. 11, even when the counterpart information are written in different formats, the counterpart manager 14 is able to appropriately identify the connection destination to start communication with the counterpart terminal.

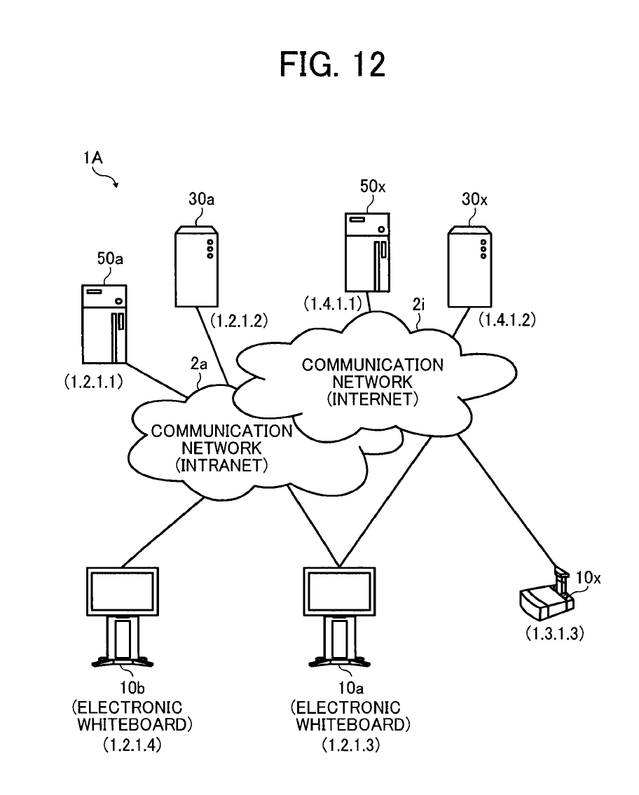

Referring to FIG. 12, a communication system 1A is described according to an embodiment of the present invention. FIG. 12 is a schematic diagram illustrating the communication system 1A according to the embodiment. In this embodiment, the terminals 10a and 10b are each implemented by an electronic whiteboard that is provided with a touch panel. The terminal (10a, 10b) is able to transmit stroke data, which is generated based on drawings drawn by the user with an electronic pen, to the counterpart terminal. The relay device 30a relays the stroke data, as part of content data, among the terminals 10 each implemented by the electronic whiteboard. The management system 50a in this embodiment operates as a server for the electronic whiteboard, and performs call control to transmit stroke data.

As described above, the terminal 10x, which is a videoconference terminal, transmits image data and audio data. The relay device 30x relays image data and audio data among the terminals 10 each implemented by the videoconference terminal. The management system 50x, which is a server for videoconferencing, performs call control to transmit image data and audio data.

In this embodiment of FIG. 12, when the counterpart manager 14 of the terminal 10a obtains the counterpart information in IP address format (S6 of FIG. 6), the terminal 10a transmits a call to the management system 50a, which is a server for electronic whiteboard. When the counterpart manager 14 of the terminal 10a obtains the counterpart information not in IP address format (such as the contact ID), the terminal 10a transmits a call to the management system 50x, which is a server for videoconferencing. In other words, based on a format of counterpart information, the terminal 10a is able to identify a particular service to be used by the terminal 10a and the counterpart terminal, such as whether it is a service using the electronic whiteboard or a service using the videoconference terminal.

According to one or more embodiments described above, the display control 13 of the terminal 10 causes the display 120 to display counterpart information of each one of one or more candidate counterpart terminals for the terminal 10. The operation input acceptor 12 of the terminal 10 receives a user selection of at least one counterpart terminal from one or more candidate counterpart terminals. When the counterpart information of the selected counterpart terminal is expressed in IP address, the transmitter/receiver 11 transmits a request for connection with the selected counterpart terminal, to the management system 50a that controls connection among the terminals via the Intranet. When the counterpart information of the selected counterpart terminal is expressed in contact ID, the transmitter/receiver 11 transmits a request for connection with the selected counterpart terminal, to the management system 50x that controls connection among the terminals via the Internet. Accordingly, even in the case where the terminal 10 needs to change a type of communication network for each counterpart terminal to start communicating, the terminal 10 can automatically determine a server (management system 50) to send a communication start request based on a format of the counterpart information of the counterpart terminal, to start communicating with the counterpart terminal through the communication network that is suitable to the counterpart terminal. This requires no instruction from a user, thus simplifying the process.

Alternatively or additionally, the counterpart manager 14 may determine a server to send the communication start request, based on a domain of the counterpart information, if the counterpart information is expressed in format including a domain name. More specifically, when a domain name included in the counterpart information matches a domain name of the local terminal 10 that is about to request for starting communication, the counterpart manager 14 selects the management system 50a as a destination to send the communication start request. When the domain name included in the counterpart information does not match the domain name of the local terminal 10, the counterpart manager 14 selects the management system 50x instead. Accordingly, the terminal 10 is able to determine, to which one of the management systems 50 the communication start request should be transmitted.

Further, the transmitter/receiver 11 of the terminal 10 receives counterpart information, respectively, from the management systems (50a, 50x, . . . ), and integrates those counterpart information into counterpart information for use by the terminal 10.

The above-described control program for the terminal 10 may be recorded in a computer-readable recording medium, in a format that is installable or executable by the general-purpose computer, for distribution. Examples of such recording medium include, but not limited to, compact disc-recordable (CD-R) and digital versatile disc (DVD). In addition, a memory storing any one of the above-described control programs, such as a recording medium including a CD-ROM or a HDD, may be provided in the form of a program product to users within a certain country or outside that country.

The terminals 10, the relay devices 30 and the management system 50 in the above-described embodiments may be configured by a single computer or a plurality of computers to which divided portions (functions) are arbitrarily allocated.

Although the case of a videoconference terminal or an electronic whiteboard has been described as an example of a communication terminal, the embodiments are not limited to the above-descried embodiments. For example, any desired apparatus having the functions of FIG. 5 may be used such as a projector, digital signage, text sharing apparatus, car navigation system, game machine, personal digital assistance (PDA), and remote diagnosis system.

In the above-described embodiments, the counterpart information is expressed in either IP address, contact ID, or address including a domain name. However, as long as a connection destination of the terminal 10 for connecting with the counterpart terminal can be identified, any other desired format of the counterpart information may be used. For example, the counterpart information may be a conference ID for identifying a connection destination, which is referred to by the relay device 30.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. A communication terminal connected to at least a first server through a first network and a second server through a second network, the communication terminal comprising:
a memory to store, for each one of one or more candidate counterpart communication terminals that the communication terminal is capable of communicating with, counterpart information to be used for connecting with the candidate counterpart communication terminal;
circuitry to receive selection of at least one candidate counterpart communication terminal from among the one or more candidate counterpart communication terminals being displayed on a display, and determine whether counterpart information of the selected candidate counterpart communication terminal that is obtained from the memory is described in a first format or a second format; and
a transmitter to transmit a communication start request for starting communication with the selected counterpart communication terminal to one of the first server and the second server based on a determination,
wherein, when the determination indicates that the obtained counterpart information is described in the first format, the communication start request is transmitted to the first server controlling communication on the first network, the first network being the Intranet, and
when the determination indicates that the obtained counterpart information is described in the second format, the communication start request is transmitted to the second server controlling communication on the second network, the second network being the Internet.

2. The communication terminal of claim 1, wherein the first format is an IP address of the candidate counterpart communication terminal, and the second format is an identification of the candidate counterpart communication terminal.

3. The communication terminal of claim 1, wherein, when the circuitry determines that the obtained counterpart information of the selected candidate counterpart communication terminal is described in a third format different than the first format and the second format, the third format being address information including a domain name,
the circuitry determines whether the domain name included in the obtained counterpart information matches a domain name of the communication terminal, and selects one of the first server and the second server as a transmission destination of the communication start request based on a determination indicating a match in domain name,
wherein, when the determination indicates that the domain name matches between the obtained counterpart information and the communication terminal, the first server is selected, and
when the determination indicates that the domain name does not match between the obtained counterpart information and the communication terminal, the second server is selected.

4. The communication terminal of claim 1, wherein the memory further stores information to be used for accessing each one of a plurality of servers, each server configured to transmit counterpart information of one or more candidate counterpart communication terminal being managed by the server, the plurality of servers including at least the first server and the second server.

5. The communication terminal of claim 1, further comprising:
a receiver to receive: 1) first counterpart information of one or more first candidate counterpart communication terminals being managed by the first server for the communication terminal, from the first server; and second counterpart information of one or more second candidate counterpart communication terminals being managed by the second server for the communication terminal, from the second server,
wherein the circuitry integrates the first counterpart information and the second counterpart information to generate the counterpart information of the one or more candidate counterpart communication terminals.

6. The communication terminal of claim 5, wherein the circuitry further
determines whether any one of the first counterpart information and the second counterpart information that are received has been registered in the memory for at least one of the one or more candidate counterpart communication terminals, and
determines to register or not to register the received counterpart information according to a user instruction.

7. A communication system comprising:
the communication terminal of claim 1;
the first server configured to transmit, to the communication terminal, first counterpart information of one or more first candidate counterpart communication terminals for the communication terminal; and
the second server configured to transmit, to the communication terminal, second counterpart information of one or more second candidate counterpart communication terminals for the communication terminal.

8. The communication system of claim 7, wherein
the first server controls transmission of first content data between the communication terminal and the selected counterpart communication terminal;
the second server controls transmission of second content data between the communication terminal and the selected counterpart communication terminal, the first content data and the second content data being different from each other in type of content data.

9. A method of controlling communication, performed by a communication terminal connected to at least a first server through a first network and a second server through a second network, the method comprising:
storing in a memory, for each one of one or more candidate counterpart communication terminals that the communication terminal is capable of communicating with, counterpart information to be used for connecting with the candidate counterpart communication terminal;
receiving selection of at least one candidate counterpart communication terminal from among the one or more candidate counterpart communication terminals being displayed on a display;
determining whether counterpart information of the selected candidate counterpart communication terminal that is obtained from the memory is described in a first format or a second format; and
transmitting a communication start request for starting communication with the selected counterpart communication terminal to one of the first server and the second server based on a determination,
wherein, when the determination indicates that the obtained counterpart information is described in the first format, the transmitting transmits the communication start request to the first server controlling communication on the first network, the first network being the Intranet, and
when the determination indicates that the obtained counterpart information is described in the second format, the transmitting transmits the communication start request to the second server controlling communication on the second network, the second network being the Internet.

10. The method of claim 9, wherein the first format is an IP address of the candidate counterpart communication terminal, and the second format is an identification of the candidate counterpart communication terminal.

11. The method of claim 9, further comprising:
determining whether the obtained counterpart information of the selected candidate counterpart communication terminal is described in a third format different than the first format and the second format, the third format being address information including a domain name; and
determining whether the domain name included in the obtained counterpart information matches a domain name of the communication terminal,
wherein, when the determination indicates that the domain name matches between the obtained counterpart information and the communication terminal, the transmitting transmits the communication start request to the first server, and
when the determination indicates that the domain name does not match between the obtained counterpart information and the communication terminal, the transmitting transmits the communication start request to the second server.

12. The method of claim 9, further comprising:
storing information to be used for accessing each one of a plurality of servers, each server configured to transmit counterpart information of one or more candidate counterpart communication terminal being managed by the server, the plurality of servers including at least the first server and the second server.

13. The method of claim 9, further comprising:
receiving: 1) first counterpart information of one or more first candidate counterpart communication terminals being managed by the first server for the communication terminal, from the first server; and second counterpart information of one or more second candidate counterpart communication terminals being managed by the second server for the communication terminal, from the second server; and
integrating the first counterpart information and the second counterpart information to generate the counterpart information of the one or more candidate counterpart communication terminals.

14. The method of claim 13, further comprising:
determining whether any one of the first counterpart information and the second counterpart information that are received has been registered in the memory for at least one of the one or more candidate counterpart communication terminals; and
determining to register or not to register the received counterpart information according to a user instruction.

15. A non-transitory recording medium which, when executed by one or more processors, cause the processors to perform a method of controlling communication by a communication terminal, the communication terminal being connected to at least a first server through a first network and a second server through a second network, the method comprising:
storing in a memory, for each one of one or more candidate counterpart communication terminals that the communication terminal is capable of communicating with, counterpart information to be used for connecting with the candidate counterpart communication terminal;
receiving selection of at least one candidate counterpart communication terminal from among the one or more candidate counterpart communication terminals being displayed on a display;
determining whether counterpart information of the selected candidate counterpart communication terminal that is obtained from the memory is described in a first format or a second format; and
transmitting a communication start request for starting communication with the selected counterpart communication terminal to one of the first server and the second server based on a determination,
wherein, when the determination indicates that the obtained counterpart information is described in the first format, the transmitting transmits the communication start request to the first server controlling communication on the first network, the first network being the Intranet, and
when the determination indicates that the obtained counterpart information is described in the second format, the transmitting transmits the communication start request to the second server controlling communication on the second network, the second network being the Internet.
